(19) United States
(12) Patent Application Publication
(10) Pub. No.: US 2019/0372827 A1
(43) Pub. Date: Dec. 5, 2019

(54) ANOMALY SEVERITY SCORING IN A NETWORK ASSURANCE SERVICE

(71) Applicant: Cisco Technology, Inc., San Jose, CA (US)

(72) Inventors: Jean-Philippe Vasseur, Saint Martin D'uriage (FR); Grégory Mermoud, Veyras (CH); David Tedaldi, Zurich (CH); Santosh Ghanshyam Pandey, Fremont, CA (US)

(21) Appl. No.: 15/996,628

(22) Filed: Jun. 4, 2018

(51) Int. Cl. H04L 12/24

(52) U.S. Cl. CPC H04L 41/0609; H04L 41/22; H04L 41/16

(57) ABSTRACT

In one embodiment, a network assurance service that monitors a network detects a set of anomalous measurements from the network over time by applying a machine learning-based anomaly detector to the measurements. The service computes, for each of the anomalous measurements, an anomaly severity score based on weighted severity factors used to compute anomaly severity scores. The severity factors include one or more of: a device type associated with the measurements, a duration of the anomalous measurements, a network impact associated with the anomalous measurements, or an aggregate metric based on distances between the measurements and a prediction band of the anomaly detector. The service sends an anomaly alert to a user interface, based on the computed anomaly severity score, and receives feedback from the user interface regarding the anomaly alert. The service adjusts, based on the received feedback, weightings of the severity factors used to compute anomaly severity scores.

### TECHNICAL FIELD

The present disclosure relates generally to computer networks, and, more particularly, to anomaly severity scoring in a network assurance service.

### BACKGROUND

Networks are large-scale distributed systems governed by complex dynamics and very large number of parameters. In general, network assurance involves applying analytics to captured network information, to assess the health of the network. For example, a network assurance system may track and assess metrics such as available bandwidth, packet loss, jitter, and the like, to ensure that the experiences of users of the network are not impinged. However, as networks continue to evolve, so too will the number of applications present in a given network, as well as the number of metrics available from the network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example network assurance system;

FIG. 4 illustrates an example architecture for performing anomaly severity scoring in a network assurance service;

FIGS. 5A-5B illustrate example anomalous measurements from a network;

FIG. 6 illustrates an example of the computation of an area under the curve (AUC) metric for anomalous network measurements;

FIG. 7 illustrates an example scatter plot of AUC metrics; and

FIG. 8 illustrates an example simplified procedure for anomaly severity scoring by a network assurance service.

### DESCRIPTION OF EXAMPLE EMBODIMENTS

### Overview

According to one or more embodiments of the disclosure, a network assurance service that monitors a network detects a set of anomalous measurements from the network over time by applying a machine learning-based anomaly detector to the measurements. The service computes, for each of the anomalous measurements, an anomaly severity score based on weighted severity factors used to compute anomaly severity scores. The severity factors include one or more of: a device type associated with the measurements, a duration of the anomalous measurements, a network impact associated with the anomalous measurements, or an aggregate metric based on distances between the measurements and a prediction band of the anomaly detector. The service sends an anomaly alert to a user interface, based on the computed anomaly severity score, and receives feedback from the user interface regarding the anomaly alert. The service adjusts, based on the received feedback, weightings of the severity factors used to compute anomaly severity scores.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

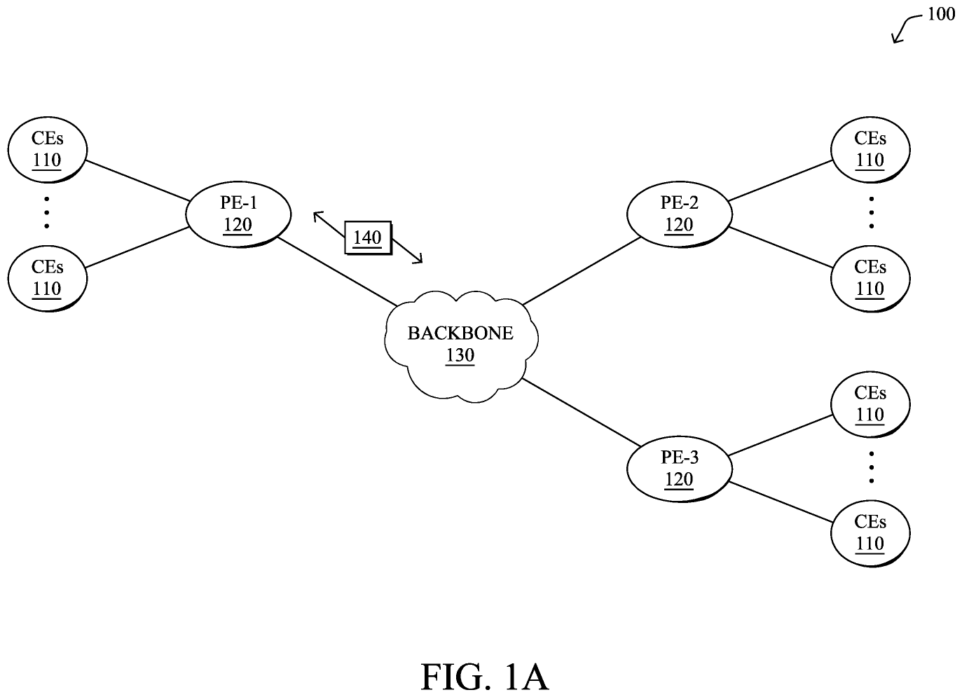

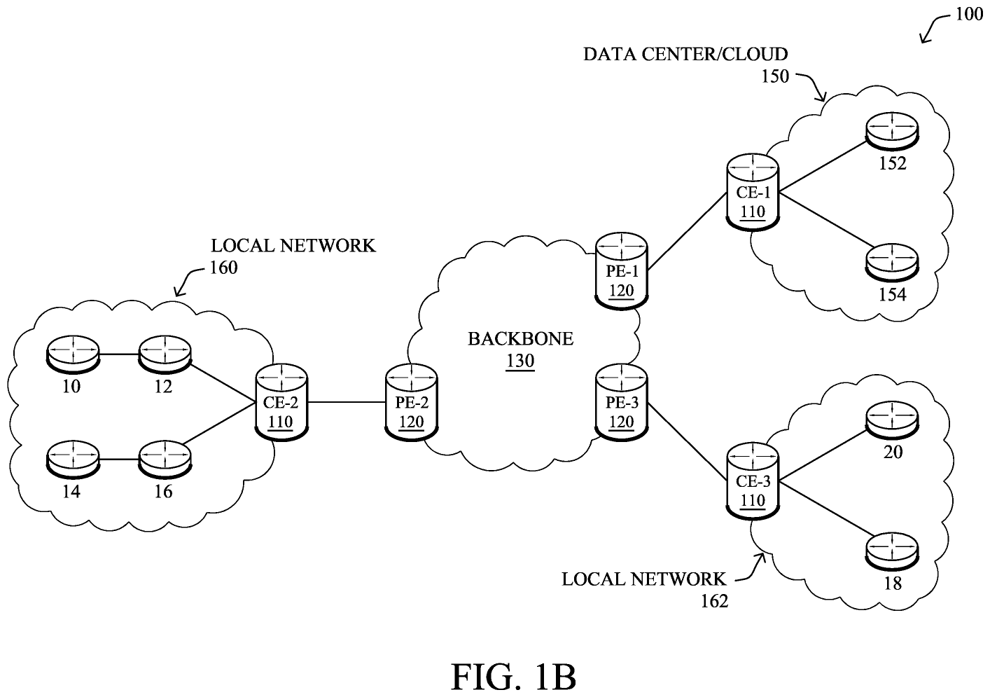

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

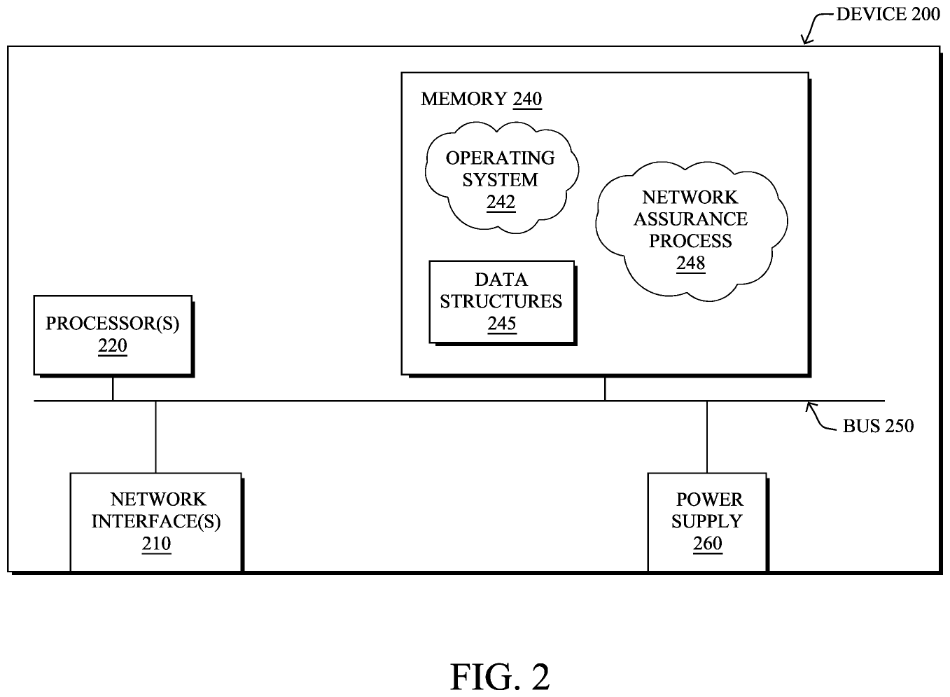

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason_code to the assurance system. To evaluate a rule regarding these conditions, the network assurance system may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

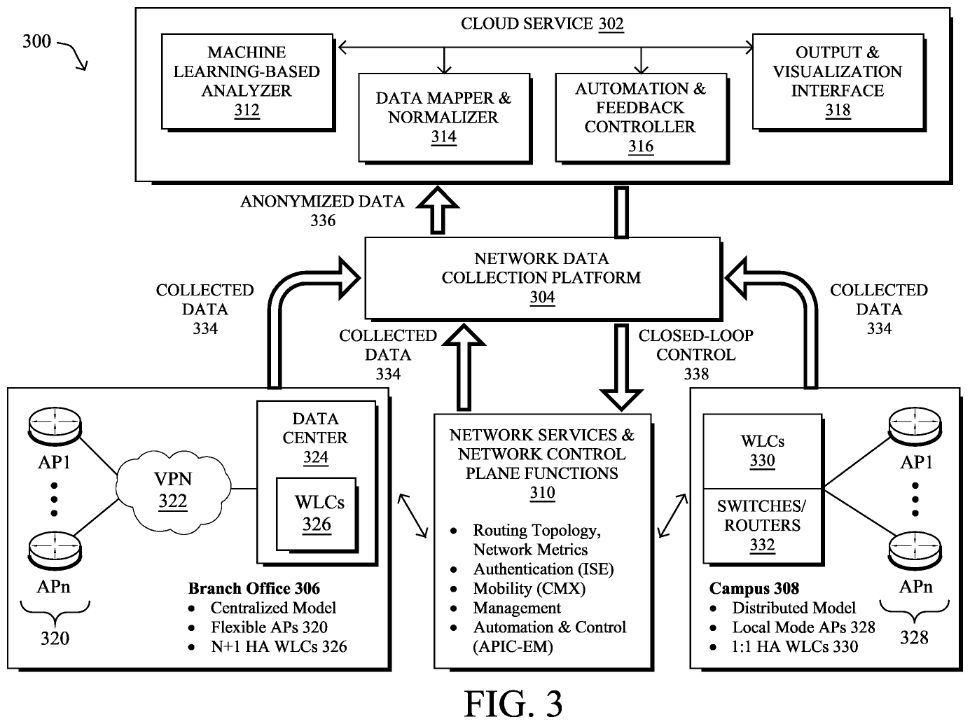

FIG. 3 illustrates an example network assurance system 300, according to various embodiments. As shown, at the core of network assurance system 300 may be a cloud service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point AP1 through nth access point, APn) through which endpoint nodes may connect. Access points 320 may, in turn, be in communication with any number of wireless LAN controllers (WLCs) 326 (e.g., supervisory devices that provide control over APs) located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point AP1 through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning (ML)-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint client device, networking device in branch office 306 or campus 308, or a network service or control plane function 310, to adjust its operations (e.g., by signaling an endpoint to use a particular AP 320 or 328, etc.).

As noted above, the network assurance service disclosed herein is capable of detecting anomalies in a monitored network using machine learning-based anomaly detection. However, many detected anomalies may be of little to no relevance to a network administrator. Indeed, a network administrator typically has a limited amount of time to review anomaly alerts raised by the network assurance service.

In the context of machine learning-based anomaly detection, the desire to raise only relevant anomaly alerts often leads to a tension between recall and precision. Notably, a system with high recall will not miss any relevant anomaly alerts, but at the expense of potentially also raising irrelevant anomaly alerts, as well. Conversely, a system with high precision will have very few irrelevant anomaly alerts, but at the expense of potentially not raising some relevant anomaly alerts. Both precision and recall are typically well defined when using supervised learning with known labels. However, in the case of unsupervised learning, there are no labels, so precision and recall become very difficult to assess.

The selection of anomalies to present to a user can be performed, in some cases, using thresholding to quantify the severity of an anomaly. When using unsupervised learning, anomalies can be raised when they “significantly” diverge from the model (e.g., diverge by a threshold amount). Lowering the threshold will increase the number of raised anomalies, which may also increase the number of irrelevant anomaly alerts (e.g., a higher number of false positives). Conversely, a higher threshold may lead to raising alerts only for stronger outliers, but at the risk of missing some issues that might otherwise be considered relevant. Of course, depending on the machine learning parameters, the parameters may be more complex than a simple threshold.

Anomaly Severity Scoring in a Network Assurance Service

The techniques herein introduce an approach for computing the severity of anomalies detected by a machine learning-based network assurance service. In some aspects, various severity factors can be considered, such as the past of a networking device (e.g., AP, AP controller, router, etc.) impacted by the anomaly, the criticality of the anomaly, the duration or degree of anomaly (e.g., distance to a predicted range computed by the anomaly detector), or the like. In further aspects, the techniques herein introduce a machine learning-based classifier that takes the severity factors as input and determines the relative importance (e.g., weightings) of each of these factors to the end user, based on anomaly alert feedback provided by the user. In yet another aspect, the techniques herein allow for the computation of a severity score for an anomaly based its weighted severity factors that can be used to control whether or not the service generates an anomaly alert for the anomaly. As a result, the service will only show the anomalies of highest interest/relevancy to the user.

Specifically, according to one or more embodiments of the disclosure as described in detail below, a network assurance service that monitors a network detects a set of anomalous measurements from the network over time by applying a machine learning-based anomaly detector to the measurements. The service computes, for each of the anomalous measurements, an anomaly severity score based on weighted severity factors used to compute anomaly severity scores. The severity factors include one or more of: a device type associated with the measurements, a duration of the anomalous measurements, a network impact associated with the anomalous measurements, or an aggregate metric based on distances between the measurements and a prediction band of the anomaly detector. The service sends an anomaly alert to a user interface, based on the computed anomaly severity score, and receives feedback from the user interface regarding the anomaly alert. The service adjusts, based on the received feedback, weightings of the severity factors used to compute anomaly severity scores.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

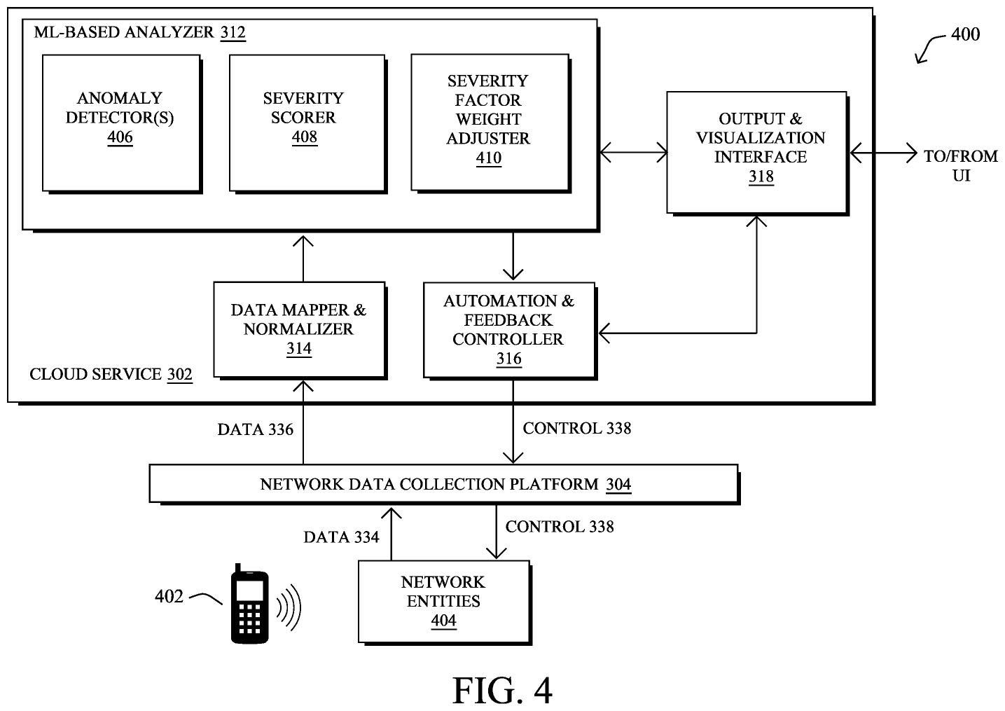

Operationally, FIG. 4 illustrates an example architecture 400 for anomaly severity scoring in a network assurance system, according to various embodiments. At the core of architecture 400 may be the following components: one or more anomaly detectors 406, a severity scorer 408, and/or a severity factor weight adjuster 410. In some implementations, the components 406-410 of architecture 400 may be implemented within a network assurance system, such as system 300 shown in FIG. 3. Accordingly, the components 406-410 of architecture 400 shown may be implemented as part of cloud service 302 (e.g., as part of machine learning-based analyzer 312 and/or output and visualization interface 318), as part of network data collection platform 304, and/or on one or more network elements/entities 404 that communicate with one or more client devices 402 within the monitored network itself. Further, these components 406-410 may be implemented in a distributed manner or implemented as its own stand-alone service, either as part of the local network under observation or as a remote service. In addition, the functionalities of the components of architecture 400 may be combined, omitted, or implemented as part of other processes, as desired.

During operation, service 302 may receive telemetry data from the monitored network (e.g., anonymized data 336 and/or data 334) and, in turn, assess the data using machine learning (ML)-based analyzer 312. For example, ML-based analyzer 312 may include any number of machine learning-based anomaly detectors 406 that look for changes in the behaviors of the monitored network(s). Other functions of ML-based analyzer 312 may include machine learning-based models used for purposes of root cause analysis, prediction, or any of the other functions described previously.

A key functionality of the techniques herein lies in the ability for the network assurance system to dynamically learn from user feedback what severity factors are actually important to the end user. This allows service 302 to better calculate severity scores for anomalies, to help triage the anomaly alerts actually sent to the user for review. The approaches introduced herein are dynamic in nature and take into account a number of severity factors, in contrast to systems that simply apply static rules to detected anomalies and report only the top N-number of anomalies.

Extensive experimentation has been conducted during which various anomalies with different characteristics were shown to users, so as to determine which of the characteristics were indeed critical to them. For example, consider the following two anomalies:
Anomaly A: Wireless on-boarding time observed was 270 ms, although the predicted range/band of the anomaly detector was between 34 ms and 123 ms (normal range), the number of impacted users was 15, the AP involved exhibited ten such issues over the past three months, the upper bound was exceeded ten times, and the total duration of the anomaly was 45 s.
Anomaly B: Wireless on-boarding time observed was 150 ms, although the predicted range/band of the anomaly detector was between 34 ms and 123 ms (normal range), the number of impacted users was 45, this was the first time that the AP involved exhibited such an issue, the upper bound was exceeded 20 times during the anomaly, and the total duration of the anomaly condition was 5 ms.

Using a static, heuristic-based approach to scoring the severities of the above anomalies would typically proceed as follows. For the sake of illustration, if the degree of the anomaly (e.g., how far is the anomaly from the prediction) is the main criteria, Anomaly A above is likely to be selected as more severe than Anomaly B. Conversely, if the impact is the main criteria, Anomaly B is the most severe anomaly, since three times as many users were impacted. Instead of using a hierarchy of criteria, another approach might be to compute a polynomic function with weights assigned to each criterion so as to compute an overall severity, which would then be used to select the top-N anomalies to be shown to the user.

According to various embodiments, the techniques herein introduce an alternate approach to heuristic-based severity scoring that:
Considers a pool of severity factors to compute the severity of an anomaly; and
Dynamically adjusts the weights of these severity factors used to compute the severity score, so as to improve the relevancy of anomaly alerts raised to the user.

In various embodiments, architecture 400 may include a severity scorer 408 that is configured to assign severity scores to anomalous conditions detected by anomaly detector(s) 406. In turn, output and visualization interface 318 may use the computed severity score, to control whether or not interface 318 should send an anomaly alert to the user interface (UI) regarding the anomaly. During operation, severity scorer 408 may compute the severity score based on any or all of the severity factors detailed below.

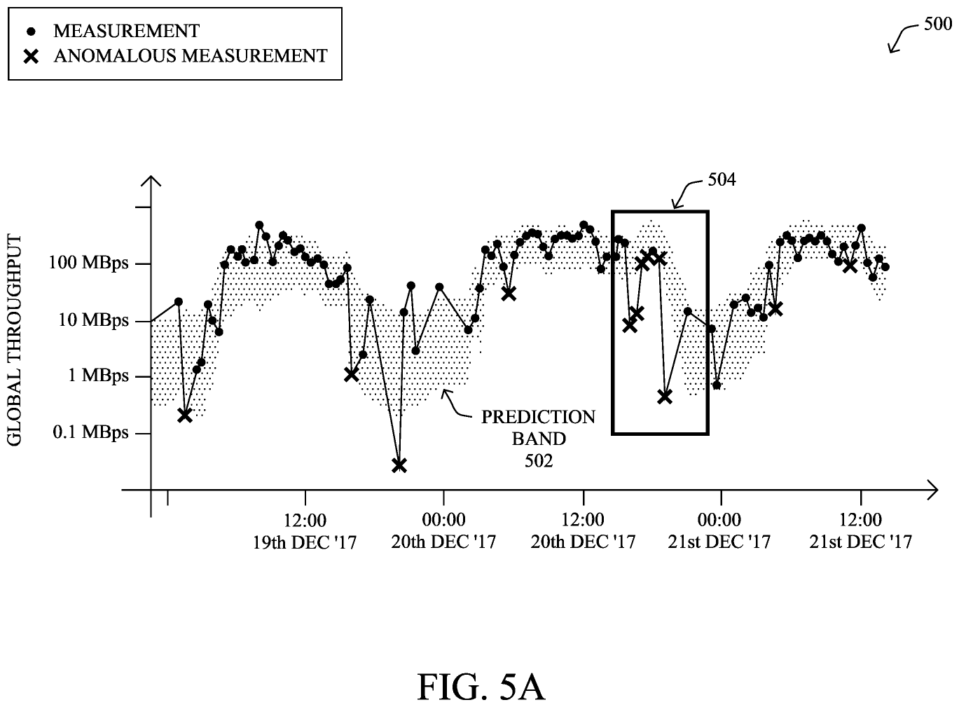

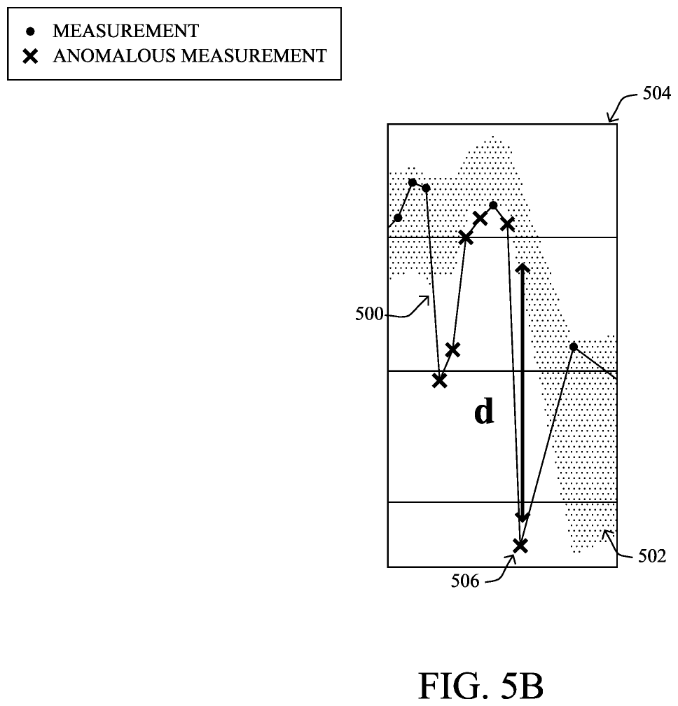

One severity factor that severity scorer 408 may consider in the computation of the anomaly severity score is the distance to bound (DTB) of the anomalous network measurement. In general, the DTB is a scalar measuring how “far” the anomaly is from the upper/lower bound of the predicted range of anomaly detector(s) 406. An example of such a DTB is shown in FIGS. 5A-5B.

In FIG. 5A, a plot 500 is shown of global throughput measurements taken from a monitored network at discrete points in time over the span of several days. As shown, a machine learning-based anomaly detector was applied to each of the global throughput measurements in plot 500, to determine whether the measurement under analysis is considered anomalous. Notably, the anomaly detector may model the behavior of the monitored network, to predict a range of measurement values that would be considered ‘normal’ network behavior. Such a prediction band 502 is also shown in FIG. 5A. Thus, whenever a measurement value in plot 500 falls outside of prediction band 502, it may be deemed anomalous by the anomaly detector.

Portion 504 of FIG. 5A is shown in greater detail in FIG. 5B. As shown, a number of measurements from plot 500 were deemed anomalous by the anomaly detector, as the fall outside of the prediction band 502 of the detector.

As noted above, the network assurance service may calculate the DTB for a given anomalous measurement. For example, consider the anomalous measurement 506 shown in FIG. 5B. In such a case, the service may compute the DTB of anomalous measurement 506 as the scalar distance, d, between the measurement and the bound of prediction band 502 for that time. Note that d could be an absolute or relative metric, in various embodiments.

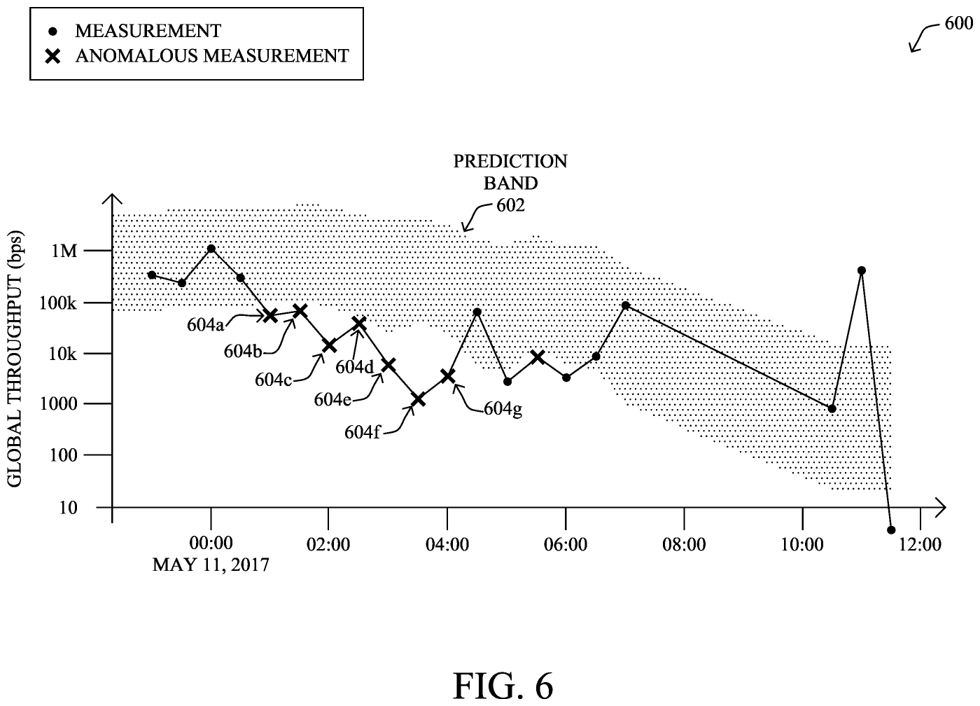

Referring again to architecture 400 in FIG. 4, severity scorer 408 may use the DTB of an anomalous measurement as a severity factor, to compute the severity score of an anomaly. However, it may very well be the case that an anomaly detector 406 identifies a series of anomalous measurements over time. In various embodiments, rather than simply considering the DTB of the most recent anomalous measurement in the severity score computation, severity scorer 408 may also take into account the DTBs of the set of anomalous measurements (e.g., as an aggregate of the DTBs). For example, in one embodiment, severity scorer 408 may calculate the aggregate metric from the DTBs as an area between the anomalous measurements and the prediction band of the anomaly detector 406. FIG. 6 illustrates such an aggregation.

As shown in FIG. 6, consider plot 600 of global throughput measurements from the monitored network over a number of hours at thirty minute intervals. Between 1:30 AM and 4:00 AM, measurements 604a-604g may be deemed anomalous, as they each fall outside of the prediction band 602 of the anomaly detector assessing measurements 604a-604g. With respect to anomalous measurement 604g, one approach may be to simply consider the DTB of this measurement (e.g., the distance from measurement 604g to prediction band 602. However, in further embodiments, an aggregate of the DTBs of anomalous measurements 604a-604g can be used as one of the severity factors for computation of the severity score.

In one embodiment, the aggregate metric may be an area under the curve (AUC) metric that quantifies the area between the anomalous measurements 604a-604g and prediction band 602. For example, the AUC metric for the situation shown in FIG. 6 may be computed as the sum of all DTBs of anomalous measurements 604a-604g. Note that it may be necessary, in further embodiments, to take the logarithmic or other transform of the AUC as the severity factor, to manage large areas. In addition, the aggregate metric may be computed by taking into account the continuous series of prior anomalous measurements from plot 600, a predefined number of prior anomalous measurements, a set of anomalous measurements that occurred within a defined time period (e.g., in the prior two hours, etc.), and/or any other anomalous measurements according to other criteria.

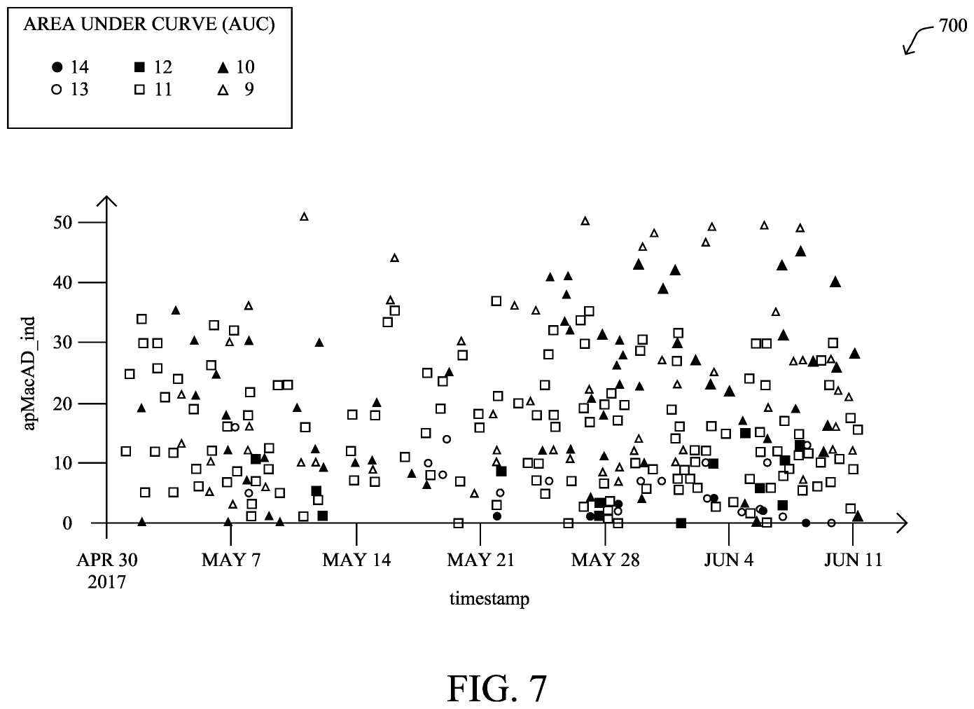

FIG. 7 illustrates an example scatter plot 700 of AUC metrics computed over a number of weeks for a plurality of AP radios. As shown, certain AUC values are higher than others, with the largest AUC values being associated with a certain radio.

Referring again to architecture 400 in FIG. 4, another severity factor that severity scorer 408 may consider when computing an anomaly severity score relates to the past anomaly events exhibited by a networking device (e.g., wireless AP, AP controller, router, etc.), in various embodiments. Indeed, it may be more critical to fix issues on first networking device that experiences recurring issues with relatively low impact, than on a second network device that experiences a one-time, higher impact issue. In some embodiments, this metric may be computed based on a policy that takes into account all anomalies for a given networking device (e.g., within a specified time or in total) and/or all anomalies of the same type. To that end, this metric may increase with frequency of anomalies associated with a given networking device. For example, one approach may be to add a penalty whose value is relative to the impact until crossing a given threshold value (Max value), at which point such value decreases exponentially. In another embodiment, the trends in this metric may be used (e.g., over the past X weeks, Y days, Z hours), along with future trends.

In another embodiment, a further severity factor that severity scorer 408 may consider when computing an anomaly severity score is the duration of the issue, which is itself made of N anomalies of the same type. Indeed, high duration is often a critical aspect of an anomaly. Such a duration may be computed, in some cases, by taking into account the number of atomic anomalous measurements (e.g., the number of times the values of the measurement have fallen outside of the prediction band of anomaly detector 406).

A further severity factor that severity scorer 408 may consider when calculating the severity score of an anomaly relates to the impact of the anomaly, in various embodiments. The impact may be a variable which could be configured according to a policy (e.g., similarly to a quality of service policy), which can vary by end users (e.g., users of the UI). For example, for Anomaly A described above, the impact may be quantified by the number of users impacted by the anomaly, the nature of the devices connected (e.g., IoT medical devices), or simply the duration of the anomaly. In yet another embodiment, the impact can be dynamically computed by severity scorer 408 upon polling variables in real-time on the networking entities 404, to determine the number of users impacted, the amount of traffic on the device, the nature of the applications used (critical/non-critical), and/or even the set of impacted SLAs (e.g., measurement of TCP retransmits using Deep Packet Inspection on the networking device, etc.).

By way of example, severity scorer 408 may score the severity of an anomaly detected by anomaly detector(s) 406 according to the following:

$$severity = {\sum }_{t - 1}^{n} {w}_{i} {F}_{i}$$

where Fᵢ is the i^{th} severity factor, as detailed above, and wᵢ is a weighting applied to the factor. As would be appreciated, a severity score can be computed based on the severity factors in any number of different ways. Using the severity score for the anomaly, output and visualization interface 318 may then determine whether or not to send an anomaly alert to the UI for the detected anomaly (e.g., if the severity score is above a threshold, by ranking of anomaly severity scores, etc.).

According to various embodiments, architecture 400 may also include a severity factor weight adjuster 410 configured to dynamically adjust the weights applied by severity scorer 408 to the severity factors when computing anomaly severity scores. In general, this adjustment may be based on feedback provided by the user for various anomaly alerts sent by output and visualization interface 318 for display. This feedback may simply be an indication that the user views the anomaly alert as relevant or irrelevant or, in further cases, be on a sliding scale (e.g., 0-5 stars, etc.).

As would be appreciated, different end users may use different criteria to consider the relevancy of an anomaly. For example, consider the case of a university in which hundreds of students are impacted by throughput issues in a classroom. In this case, the impact (e.g., number of affected students) may be of greater importance to the network administrator than the actual time duration of the issue. Conversely, in a hospital where medical devices are connected to the network, the AUC metric or DTB may be the most important factor to the user.

In various embodiments, severity factor weight adjuster 410 may use machine learning to determine the weight/importance of each of the severity factors for a given user or set of users. To that end, severity factor weight adjuster 410 may include a classifier that takes as input a set of severity factors of an anomaly (e.g., type of anomaly, duration, number of times the anomaly was outside of the predicted range, prior anomalies, etc.), and output an indication as to whether the detected anomaly would be of relevance to the user. Training of the classifier can be achieved through the use of anomaly alert feedback from the UI for anomalies reported using different severity factor weightings. Once the classifier has reached a minimum desired precision (e.g., 70%, etc.), this means that the weighting of each severity factor can then be used to assess the relative contribution of each severity factor to the severity score, to the end of forecasting the relevancy of the anomaly to the user. At the same time, the learned model can be used to adjust the weightings for the severity score function, in a data driven fashion. For example, the classifier of severity factor weight adjuster 410 may be a logistic regression classifier defined as follows:

P_{good}(feat₁, . . . ,featₙ)=σ(β₀+feat₁β₁+ . . . +featₙβₙ)

where P_{good} is the probability of positive feedback for an anomaly alert (e.g., the user deems the alert relevant), featᵢ is the i^{th} severity factor, and β are the applied weightings. The logistic function may be defined as follows:

$$σ ( t ) = \frac{{e}^{t}}{{e}^{t} + 1}$$

The so estimated parameters can be thought as optimally rebalancing the input variables in accordance with the specific preference of a user. In another embodiment, the model of severity factor weight adjuster 410 can be represented by an artificial neural network or other kind of classifiers.

Another potential function of severity factor weight adjuster 410 may be to enter into an exploration mode whereby lower severity anomalies are purposely reported by output and visualization interface 318 to the UI, to obtain relevancy feedback from the user(s). By gathering further feedback, this allows severity factor weight adjuster 410 to explore the effects of other severity factor weightings on the perceived relevancy of the reported anomaly.

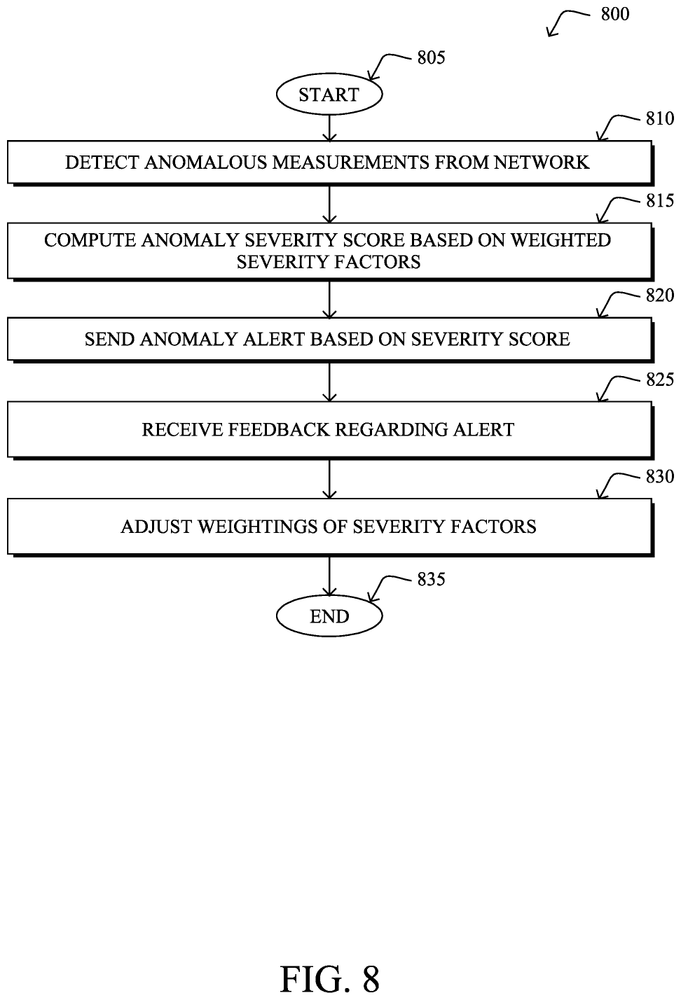

FIG. 8 illustrates an example simplified procedure for anomaly severity scoring in a network assurance service, in accordance with one or more embodiments described herein. For example, a non-generic, specifically configured device (e.g., device 200) may perform procedure 800 by executing stored instructions (e.g., process 248), to implement a network assurance service that monitors a network. The procedure 800 may start at step 805, and continues to step 810, where, as described in greater detail above, the network assurance service may detect a set of anomalous measurements from the network over time by applying a machine learning-based anomaly detector to the measurements. Such an anomaly detector may model the behavior of the measurements over time and determine whether a given measurement value is outside of the prediction band of the model. The measurements from the network may be of any form such as, but not limited to, any or all of the following: wireless clients in the network, network throughput, wireless client onboarding failures, wireless authentication failures, or dynamic host configuration protocol (DHCP) failures.

At step 815, as detailed above, the network assurance service may compute, for each of the anomalous measurements, an anomaly severity score based on weighted severity factors used by the service to compute anomaly severity scores. In various embodiments, these severity factors may include, but are not limited to, a device type associated with the measurements, a duration of the anomalous measurements, a network impact associated with the anomalous measurements, or an aggregate metric based on distances between the anomalous measurements and a prediction band of the anomaly detector. In one embodiment, the aggregate metric may be computed as an area between the anomalous measurements and the prediction band, based on DTB values for the anomalous measurements.

At step 820, the network assurance service may send an anomaly alert to a user interface based on the computed anomaly severity score, as described in greater detail above. Such an anomaly alert may include information regarding the anomaly, such as when the anomalous metric was observed in the monitored network, the impact of the anomaly (e.g., in terms of number of affected users, etc.), the types of clients affected by the anomaly, or the like.

At step 825, as detailed above, the network assurance service may receive feedback from the user interface regarding the anomaly alert. In general, the feedback may indicate the relevancy of the anomaly alert to the user of the user interface. For example, the feedback may simply be a binary indication of relevancy (e.g., relevant vs. irrelevant) or, in more complex scenarios, be on a sliding scale (e.g., from 0-5 stars, 0-10 stars, etc.).

At step 830, the network assurance service may adjust, based on the received feedback, weightings of the severity factors used by the service to compute anomaly severity scores, as described in greater detail above. In various embodiments, the network assurance service may use the feedback as input to a machine learning model, such as a classifier, to assign weightings to the severity factors, in order to maximize positive feedback for anomaly alerts sent by the service to the user interface. In other words, over time, the service may learn the optimal weightings of the severity factors used to compute the anomaly severity scores, to ensure that the anomaly alerts sent to the user are considered relevant by the user. As would be appreciated, certain severity factors can even be ignored in the computation of the severity score for an anomaly by setting their weights to be zero. Procedure 800 then ends at step 835.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce a mechanism for anomaly severity scoring in a network assurance service. In particular, the techniques herein allow the service to report only those anomalies that an end user deems relevant, effectively triaging the anomalies that are reported.

While there have been shown and described illustrative embodiments that provide for anomaly severity scoring in a network assurance service, it is to be understood that various other adaptations and modifications may be made within the spirit and scope of the embodiments herein. For example, while certain embodiments are described herein with respect to using certain models for purposes of anomaly detection, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
detecting, by a network assurance service that monitors a network, a set of anomalous measurements from the network over time by applying a machine learning-based anomaly detector to the measurements;
computing, by the service and for each of the anomalous measurements, an anomaly severity score based on weighted severity factors used by the service to compute anomaly severity scores, wherein the severity factors comprise one or more of: a device type associated with the measurements, a duration of the anomalous measurements, a network impact associated with the anomalous measurements, or an aggregate metric based on distances between the anomalous measurements and a prediction band of the anomaly detector;
sending, by the service, an anomaly alert to a user interface based on the computed anomaly severity score;
receiving, at the service, feedback from the user interface regarding the anomaly alert; and
adjusting, by the service and based on the received feedback, weightings of the severity factors used by the service to compute anomaly severity scores.

2. The method as in claim 1, wherein adjusting the weightings of the severity factors comprises:
using, by the service, the feedback regarding the anomaly alert as input to a machine learning-based model, wherein the model uses the feedback to assign weightings to the severity factors in order to maximize positive feedback for anomaly alerts sent by the service to the user interface.

3. The method as in claim 1, wherein the measurements are indicative of one or more of: wireless clients in the network, network throughput, wireless client onboarding failures, wireless authentication failures, or dynamic host configuration protocol (DHCP) failures.

4. The method as in claim 1, further comprising:
calculating, by the service, the duration of the anomalous measurements based on the number of anomalous measurements.

5. The method as in claim 1, further comprising:
calculating, by the service, the distances between the anomalous measurements and the prediction band of the anomaly detector;
determining, by the service, the aggregate metric as an area between the anomalous measurements and the prediction band, based on the calculated distances.

6. The method as in claim 1, further comprising:
determining, by the service, the network impact by applying a policy to at least one of: a number of clients affected by the anomalous measurements or type of client affected by the anomalous measurements.

7. The method as in claim 1, wherein the device type comprises at least one of: a wireless access point or a wireless access point controller in the network.

8. The method as in claim 1, further comprising:
adjusting, by the service, the weightings of the severity factors used by the service to compute anomaly severity scores, to explore how the adjusted weightings affect anomaly alert feedback received from the user interface.

9. An apparatus, comprising:
one or more network interfaces to communicate with a network;
a processor coupled to the network interfaces and configured to execute one or more processes; and
a memory configured to store a process executable by the processor, the process when executed configured to:
detect a set of anomalous measurements from the network over time by applying a machine learning-based anomaly detector to the measurements;
compute, for each of the anomalous measurements, an anomaly severity score based on weighted severity factors used by the apparatus to compute anomaly severity scores, wherein the severity factors comprise one or more of: a device type associated with the measurements, a duration of the anomalous measurements, a network impact associated with the anomalous measurements, or an aggregate metric based on distances between the anomalous measurements and a prediction band of the anomaly detector;
send an anomaly alert to a user interface based on the computed anomaly severity score;
receive feedback from the user interface regarding the anomaly alert; and
adjust, based on the received feedback, weightings of the severity factors used by the apparatus to compute anomaly severity scores.

10. The apparatus as in claim 9, wherein the apparatus adjusting the weightings of the severity factors by:
using the feedback regarding the anomaly alert as input to a machine learning-based model, wherein the model uses the feedback to assign weightings to the severity factors in order to maximize positive feedback for anomaly alerts sent by the apparatus to the user interface.

11. The apparatus as in claim 9, wherein the measurements are indicative of one or more of: wireless clients in the network, network throughput, wireless client onboarding failures, wireless authentication failures, or dynamic host configuration protocol (DHCP) failures.

12. The apparatus as in claim 9, wherein the process when executed is further configured to:
calculate the duration of the anomalous measurements based on the number of anomalous measurements.

13. The apparatus as in claim 9, wherein the process when executed is further configured to:
calculate the distances between the anomalous measurements and the prediction band of the anomaly detector;
determine the aggregate metric as an area between the anomalous measurements and the prediction band, based on the calculated distances.

14. The apparatus as in claim 9, wherein the process when executed is further configured to:
determine the network impact by applying a policy to at least one of: a number of clients affected by the anomalous measurements or type of client affected by the anomalous measurements.

15. The apparatus as in claim 9, wherein the device type comprises at least one of: a wireless access point or a wireless access point controller in the network.

16. The apparatus as in claim 9, wherein the process when executed is further configured to:
adjust the weightings of the severity factors used by the apparatus to compute anomaly severity scores, to explore how the adjusted weightings affect anomaly alert feedback received from the user interface.

17. A tangible, non-transitory, computer-readable medium storing program instructions that cause a network assurance service that monitors a plurality of networks to execute a process comprising:
detecting, by the network assurance service, a set of anomalous measurements from the network over time by applying a machine learning-based anomaly detector to the measurements;
computing, by the service and for each of the anomalous measurements, an anomaly severity score based on weighted severity factors used by the service to compute anomaly severity scores, wherein the severity factors comprise one or more of: a device type associated with the measurements, a duration of the anomalous measurements, a network impact associated with the anomalous measurements, or an aggregate metric based on distances between the anomalous measurements and a prediction band of the anomaly detector;
sending, by the service, an anomaly alert to a user interface based on the computed anomaly severity score;
receiving, at the service, feedback from the user interface regarding the anomaly alert; and
adjusting, by the service and based on the received feedback, weightings of the severity factors used by the service to compute anomaly severity scores.

18. The computer-readable medium as in claim 17, wherein adjusting the weightings of the severity factors comprises:
using, by the service, the feedback regarding the anomaly alert as input to a machine learning-based model, wherein the model uses the feedback to assign weightings to the severity factors in order to maximize positive feedback for anomaly alerts sent by the service to the user interface.

19. The computer-readable medium as in claim 17, wherein the measurements are indicative of one or more of: wireless clients in the network, network throughput, wireless client onboarding failures, wireless authentication failures, or dynamic host configuration protocol (DHCP) failures.

20. The computer-readable medium as in claim 17, wherein the process further comprises:
calculating, by the service, the distances between the anomalous measurements and the prediction band of the anomaly detector;
determining, by the service, the aggregate metric as an area between the anomalous measurements and the prediction band, based on the calculated distances.
